(19) United States
(12) Patent Application Publication
(10) Pub. No.: US 2015/0103646 A1
(43) Pub. Date: Apr. 16, 2015

(54) ALLOCATING NETWORK BANDWITH

(71) Applicants: Jean Tourrilhes, Mountain View, CA (US); Kevin Christopher Webb, San Diego, CA (US); Sujata Banerjee, Palo Alto, CA (US)

(72) Inventors: Jean Tourrilhes, Mountain View, CA (US); Kevin Christopher Webb, San Diego, CA (US); Sujata Banerjee, Palo Alto, CA (US)

(73) Assignee: Hewlett-Packard Development Company, L.P., Houston, TX (US)

(21) Appl. No.: 14/395,625

(22) PCT Filed: Apr. 30, 2012
(86) PCT No.: PCT/US2012/035866

§ 371 Date: Oct. 20, 2014

(51) Int. Cl. H04L 12/923; H04L 12/911; H04L 12/801; H04L 12/26

(52) U.S. Cl. CPC H04L 47/762; H04L 43/0882; H04L 47/783; H04L 47/10
USPC 370/229

(57) ABSTRACT

As an example, a system and method is provided for allocating network bandwidth. The method includes identifying congested and uncongested links using a tenant demand for each link and a tenant bandwidth cap. A portion of the tenant bandwidth cap may be allocated to each uncongested link based on the tenant demand on the uncongested link and the tenant bandwidth cap. Additionally, the remainder of the tenant bandwidth cap may be allocated to the tenants congested links based on a link capacity.

### BACKGROUND

Computer networks may provide centralized resources to multiple clients, or tenants, over communication links. A tenant is any entity that uses the resources of a network. As used herein, tenant segregation refers to the isolation of each tenant that accesses the network, such that the networking policies of each tenant are met by the network provider. In this manner, each tenant is unaware of other tenants using the resources of the network. A networking policy may include the networking services used by the tenant as well as the amount of data the tenant will place on the network. Tenant segregation ensures each tenant accesses the information belonging to that tenant and not the information of other tenants that access the same network.

As used herein, a communication link, or link, is a physical or wireless connection between the various resources of the network, between resources of the network and tenants that use the network, or between multiple networks. Communication links within a network are typically shared on a best effort basis. In a best effort scheme, each packet of data, regardless of the tenant where the packet originated, has an equal probability of accessing the link. Network protocols such as TCP/IP use a best effort scheme and may attempt to implement data flow fairness, but tenants can negatively impact other tenant's network usage by having multiple data flows or not using the TCP/IP protocol. As a result, a tenant may use more than the tenant's designated share of data flow across the network.

The quality of service (QoS) for a tenant of a network can dictate aspects of resource sharing across the network, including the designated amount of data flow for each tenant across the network. The designated data flow for a tenant can define the fair share of data flow for the tenant. The QoS that each tenant expects from a network provider may be formally agreed upon in a service level agreement (SLA). The network provider is tasked with providing services to each tenant that meet the QoS agreed upon under the terms of the SLA. To meet the terms of the SLA for each tenant, the network provider may implement over-provisioning of network resources or other mechanisms to control data flows and access to resources within the network.

### BRIEF DESCRIPTION OF THE DRAWINGS

Certain examples are described in the following detailed description and in reference to the drawings, in which:

FIG. 1 is a block diagram of a network that allocates global network bandwidth, in accordance with examples;

FIG. 2 is a table that illustrates the allocation of bandwidth on a best effort basis, in accordance with examples;

FIG. 3 is a process flow diagram hat allocates network bandwidth, in accordance with examples;

FIG. 4 is process flow diagram that identifies congested and uncongested links within a network using distributed rate limiting, in accordance with examples;

FIG. 5 is a process flow diagram that allocates global network bandwidth, in accordance with examples;

FIG. 6 is a table that illustrates the allocation of bandwidth, in accordance with examples; and

FIG. 7 is a block diagram showing a tangible, non-transitory computer-readable medium that stores a protocol adapted to allocate network bandwidth, in accordance with examples.

### DETAILED DESCRIPTION OF SPECIFIC EMBODIMENTS

Traditional QoS tools, such as differentiated services (DiffServ), can be used to control how network resource sharing is done and can share network links according to the chosen QoS policies. However, traditional QoS frameworks may not fully implement tenant segregation. The goals of traditional QoS frameworks typically include prioritizing traffic and enforcing latency guarantees. However, these goals do not ensure tenant segregation, as a tenant may be aware of other tenants on the network as traffic across the network is prioritized and latency guarantees are enforced. Additionally, traditional QoS tools may operate under a principle of traffic classification, in which the data from each tenant is placed into a limited number of traffic classes as opposed to differentiating network traffic based on each tenant's flow of traffic. Each traffic class can be treated differently according to the specified QoS of that class. The traffic classes may be assigned different rate limits or be prioritized. As used herein, a rate limit refers to the maximum amount of traffic that can be sent using a network. The number of traffic classes may be limited in traditional QoS tools. Further, the limited number of classes may not support a large number of tenants, as the different QoS policies may outnumber the traffic classes within a network.

Examples described herein allocate network bandwidth. Specifically, some examples allocate network bandwidth using distributed rate limiting (DRL). As used herein, bandwidth describes a rate of data transfer, or throughput, of each communication link. Each tenant of a network is allocated a fair share bandwidth of the network based on the QoS expected by the tenant and a DRL assignment of the tenant. As used herein, a fair share refers to the designated quantity of network bandwidth a tenant may access in accordance with a specified QoS, as determined by the capacity of the network, or as specified in a SLA that is designed to exploit the bandwidth of the communication links. As a result of the fair allocation of bandwidth across the communication links of the network, data congestion across the links is reduced. In examples, each tenant has a global rate target. If a tenant has a high rate target relative to the capacity of one link and uses few other links of the network, the tenant may be allocated a large portion of the one link. If the tenant has a small rate target relative to the capacity of one link and uses many other links of the network, the tenant may be allocated a small portion of the one link, relative to the capacity of the link. In this manner, the probability that each tenant is close to its global rate target is maximized. Additionally, the tenants do not exceed their respective global rate target and are limited such that they do not consume all resources of the network. Furthermore, such an allocation of network bandwidth enables each tenant to access the network at the terms agreed upon in the SLA or some other QoS arrangement, effectively segregating the tenants by keeping each tenant within the tenant's specified rate target.

For ease of description, a link is congested when a bandwidth cap of the communication link is met. The bandwidth cap is the specified maximum bandwidth of a network component. The bandwidth cap of a component of the network may be specified by the manufacturer of the component or determined during testing. A link is uncongested when the bandwidth cap has not been met. Accordingly, when the bandwidth cap has not been met, there is additional bandwidth available on the link. it is envisioned that other standards may be used to define congested and uncongested links, and thus the present techniques are not limited to a single definition of congested and uncongested links. For example, a network service provider may set standards regarding when a link is deemed congested or uncongested by using a percent of the link's total capacity as a threshold for congestion.

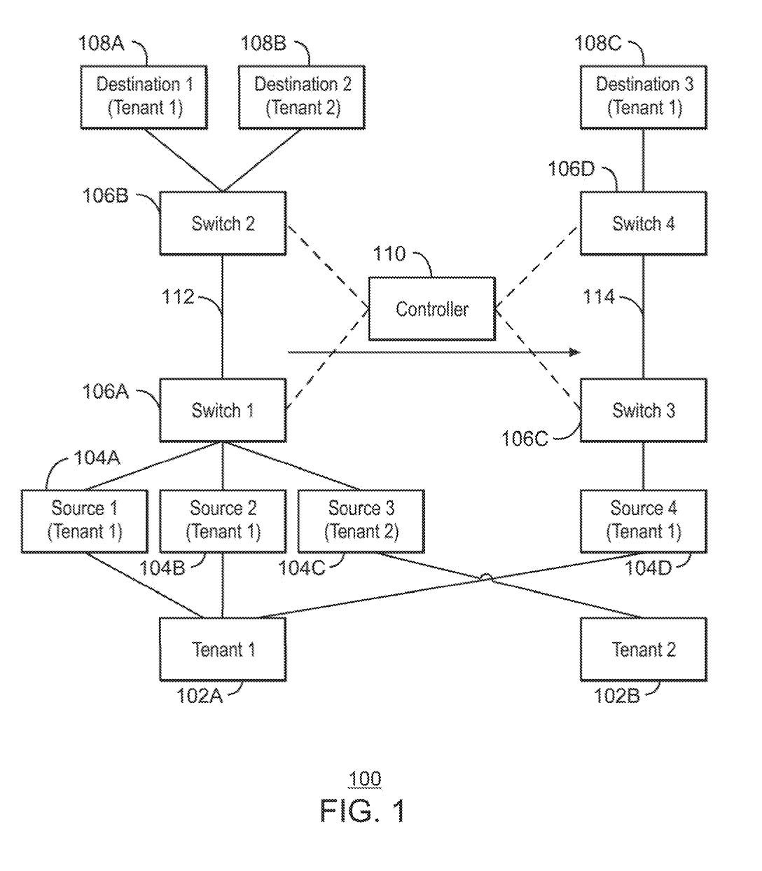

FIG. 1 is a block diagram of a network 100 that allocates global network bandwidth, in accordance with examples. In some examples, the network 100 may be a local area network, wide area network, wireless network, virtual private network, computer network, telecommunication network, peer to peer network, data center network, or any combinations thereof. The network 100 includes tenant 1 at reference number 102A and tenant 2 at reference number 102B. Further, the network 100 includes traffic sources 104A, 104B, 104C, and 104D. The traffic sources 104A, 104B, 104C, and 104D may send traffic through a plurality of switches 106A, 106B, 106C, and 106D to network destinations 108A, 108B, and 108C. For ease of description, a limited number of tenants, traffic sources, switches, and network destinations are shown in network 100. However, the network 100 may include any number of tenants, traffic sources, switches, and network destinations. As used herein, a traffic source is a component or device, such as a computer, network interface card (NIC), or software module that forwards traffic from a tenant to a switch within the network. Additionally, as used herein, a network destination is a networked component or device, such as a computer, network interface card (MC), or software module, that has a capability to perform a function of the network, such as processing information sent by the traffic sources.

In examples, the tenant 102A may send traffic across the network 100 by using traffic sources 104A and 104B. Thus, traffic sources 104A and 104B are designated as being allocated to the tenant 102A. Similarly, the tenant 102B may send traffic across the network 100 by using traffic source 104C. Traffic source 104C is shown as being allocated to the tenant 102B. The traffic senders 104A, 104B, and 104C may send traffic to the switch 106A and the switch 106B. The switch 106B may send the traffic to network destinations 108A and 108B. As shown in network 100, the traffic from the tenant 102A is routed to the network destination 108A, while the traffic from the tenant 102B is routed to the network destination 108B. Additionally, a traffic source 104D may send traffic to another network destination 108C through switches 1060 and 1060. In this example, the tenant 102A is using traffic sources 104A, 1048, and 1040, while the tenant 1028 is using the traffic source 104C.

A network controller 110 may be a device that controls the switches 106A, 106B, 106C, and 1060 and determines how traffic is routed through the network. In examples, the network 100 is a data center network, and the traffic from tenants 102A and 102B contains data that is to be processed within the network 100. The tenants 102A and 102E may use the resources connected to the network to process data or perform some networking functions that are traditionally done by network devices. In some examples, the tenants are corporations, businesses, organizations, individuals, or combinations thereof that use resources on the network. Additionally, in some examples, multiple tenants use multiple traffic sources, links, controllers, network destinations, computing nodes, network devices, network programs, other network resources, or combinations thereof, at the same time. The tenants 102A and 102B may request that the data be processed on the network, but the network controller 110 itself controls the processing requested by the tenants. Furthermore, the network controller 110 may track and allocate resources of the network on a per tenant basis. In some examples, the network controller 110 organizes all or a portion of the devices in the network. In other examples, the network is a peer-to-peer network where controls of the network are distributed among multiple devices in the network 100.

In the example of FIG. 1, both the tenant 102A and the tenant 102B send traffic to the switch 106A, which routes the traffic over a communication link 112 to the switch 106B, which routes the traffic of the tenant 102A to the network destination 108A. However, in this example, the traffic source 104C also sends the traffic of tenant 102B to the switch 106A, which routes the traffic over the link 112 to the switch 106B. At the switch 106B, the traffic from the traffic source 144C is routed to the network destination 108B. The tenant 102A also sends traffic to the switch 106C, which routes the traffic from the traffic source 104C over a link 114 to the switch 106C. At the switch 106C, the traffic of tenant 102A is routed to the network destination 108C.

The network 100 may have devices or mechanisms that prevent the capacity of network destinations 108A, 108B, and 148C from being exceeded by the traffic sources or tenants, such as rate limiter devices. However, the communication links 112 and 114 of the network may also be susceptible to congestion when traffic demands exceed the capacity of the communication links. The communication links shown are illustrative of the types of communication links that may be present in a network. However, the communication links shown are not exhaustive. Furthermore, it is assumed that other communication links may exist within the network, such as communication links between various software modules and hardware devices. The communication links 112 and 114 can become congested as the network allocates bandwidth of the links on a best effort basis. When allocating links on a best effort basis, the network provider makes an attempt to provide each tenant with enough bandwidth to satisfy that tenant's workload. However, an assurance of a particular quality of service (QoS) is not made, nor is any tenant assured a certain priority within the network.

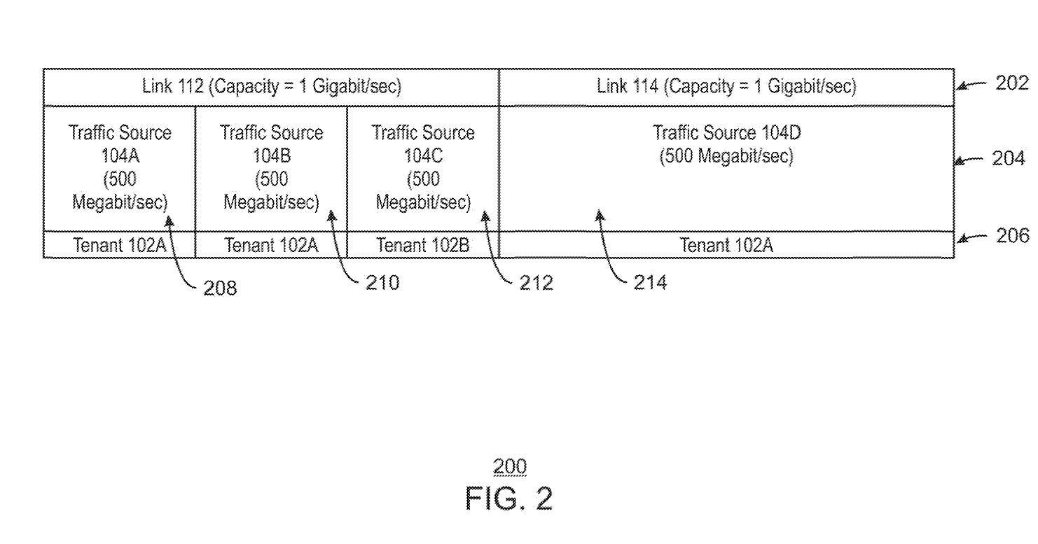

FIG. 2 is a table 200 that illustrates the allocation of bandwidth on a best effort basis. In FIG. 2, communication links 112 and 114 are located in row 202 of table 200. Each of the communication links 112 and 114 have a capacity of 1 gigabits per second. In row 204, each traffic source 104A, 104B, 104C, and 104D has a traffic capacity of 500 megabits per second. Row 206 lists the tenants 102A and 1028 of the network. The columns under each communication link indicates the component that communicates using the communication link. For example, traffic sources 104A, 104B and 104C in row 204 are listed under communication link 112 in row 202. Similarly, traffic source 104D is listed under communication link 114 in row 202. Likewise, each tenant in row 206 is listed in a column under the traffic source in row 204 that the tenant uses to send traffic through the network.

A field 208 representing the rate of traffic at the traffic source 104A indicates that the traffic source 104A sends traffic across link 112 at 500 megabits per second. Similarly, fields 210 and 212 indicate that the traffic sources 104B and 104C each send traffic across link 112 at a rate of 500 megabits per second. Furthermore, field 214 indicates that the traffic source 104D sends traffic across link 114 at a rate of 500 megabits per second. In this example, the link 112 is congested, as the sum of the traffic from the traffic sources 104A, 104B, and 104C exceeds the capacity of the link 112. The link 114 is uncongested, as the traffic from the single traffic source assigned to link 114 does not exceed the capacity of link 114. Further, since tenant 102A has access to more traffic sources when compared to tenant 102B, tenant 102A can implement multiple flows to use more bandwidth than designated by the SLA.

Distributed rate limiting (DRL) may be used to limit network congestion. DRL is a mechanism by which a total rate limit of the network is distributed across multiple traffic sources. The rate limit refers to the amount of traffic that crosses particular points within the network. The global aggregate rate limit of the network is the sum of the rate limit of each traffic source at any point in time. Using DRL, the global aggregate rate limit may be applied to multiple traffic sources by subdividing the global aggregate rate limit and allocating the subdivided global aggregate rate limit piecewise among the traffic sources. In a DRL implementation where all traffic across a communication link is attributed to a single tenant, that tenant may be assigned the entire aggregate rate limit of the communication link, as the tenant is the only traffic sender to which the subdivided rate limit may be allocated. In this scenario, the global aggregate rate limit is allocated to a single tenant without considering the other tenants that may be sharing the traffic source at a future point in time. Accordingly, the single tenant has an unfair allocation across a particular traffic source when other tenants attempt to access the traffic source at a future point in time. Alternatively, DRL may also be implemented such that the capacity of a communication link is not exceeded by the global aggregate rate limit. For example, all tenants sharing a link may place their entire traffic allocation on the link, with the sum of the global aggregate rate limit for those tenants being less than the capacity of the link. This implementation may cause congestion on one link, while under-utilizing the other links within the network. Most often, DRL is implemented so that the global aggregate rate limit is close to the aggregate capacity of the network as a whole. As a result, some of the links of the network may be over-utilized, or congested, due to the instantaneous traffic pattern of the tenants.

To mitigate congestion across links of a network, a weighted fair sharing mechanism may be used to allocate bandwidth across contended links to multiple tenants. The weighted fair sharing mechanism may be implemented, in part, through the use of rate limiters, which are a mechanism that limits the traffic that is sent or received at a particular point within the network. Limiters may be located at each traffic source, and each limiter may operate independently at each sender, without inter-limiter coordination. However, the use of limiters operating independently at each sender may prevent the use of a global aggregate rate limit across multiple traffic sources, as each limiter operates independently. Further, such per link weighted fair sharing also unfairly penalizes tenants that have a higher portion of their traffic on congested links when compared to tenants that have a higher portion of their traffic on uncongested links. The penalty occurs when the tenants that have a higher portion of their traffic on uncongested links use more than their fair share of the network.

To avoid penalizing tenants that have a higher portion of their traffic on congested links, a traffic matrix for each tenant may be used to allocate traffic. The traffic matrix may describe the load of each tenant on each link, and an analysis of the matrix can assure that each tenant gets a fair allocation on each link by rejecting tenants whose traffic matrix is not satisfied by the system. For example, the traffic matrix of a tenant may attempt to consume more network bandwidth than is available in the network. Such a tenant is rejected by the network, as the network is incapable of servicing the traffic matrix. Other tenants may be rejected because their traffic matrix attempts to consume more network bandwidth than is allowed by the QoS. Each tenant pre-defines its traffic matrix, which can be done for a tenant whose traffic load is predictable and static. Network tenants whose traffic is dynamic or unpredictable can either define their traffic matrix for a worst case scenario by requesting resources that will be mostly idle, or they can define their traffic matrix for an average case and be arbitrarily constrained on some links while underutilizing other links when the actual traffic of the tenant does not correspond to its traffic matrix. Such a system does not offer the ability to move allocated resources to optimize for dynamic traffic flows.

In examples, a system may coordinate and enforce aggregate rate limits for multiple tenants across a distributed set of data-center network devices. The system may implement a mechanism that enables to segregate multiple tenants using the network by taking into account tenant negotiated global rate, tenant demands, and uplink capacities of each tenant. In this manner, the traffic of the tenants is allocated to enable rate limited tenants to fairly share contended links while giving tenant performance as close as possible to their assigned rate. Additionally, in examples, the congested and uncongested links may be identified. The DRL assignment for each tenant on each link is determined. The global amount of bandwidth owed to each tenant is calculated by subtracting the total traffic assignments on uncongested links from the bandwidth cap for each tenant. Additionally, the global amount of bandwidth owed may be distributed to the congested links of the tenant.

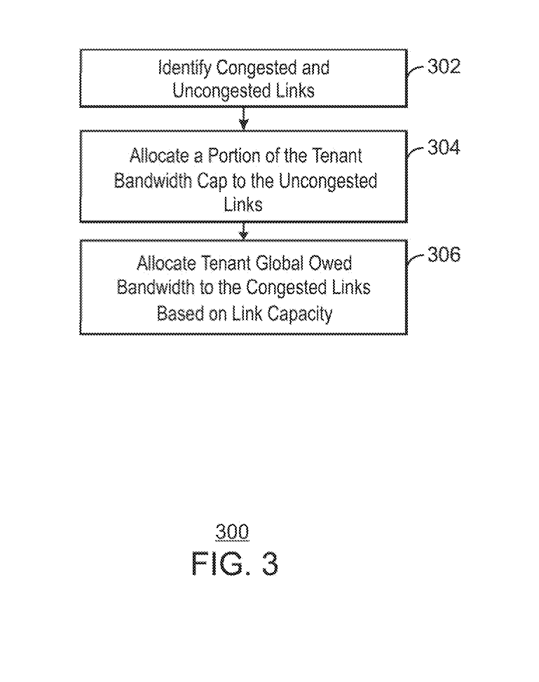

FIG. 3 is a process flow diagram 300 that allocates network bandwidth, in accordance with examples. At block 302, congested and uncongested links for a tenant may be identified using a tenant demand for each link and a tenant bandwidth cap. In examples, the congested and uncongested links are identified using distributed rate limiting (DRL) for each tenant. At block 304, a portion of the tenant bandwidth cap is allocated to the tenant's uncongested links. In examples, a global owed bandwidth may be calculated by subtracting the total traffic assignments for the tenant across the uncongested links from the total bandwidth cap for the tenant. At block 306, the remainder of the tenant's bandwidth cap is allocated to the tenant's congested links based on a link capacity. In examples, the remaining global owed bandwidth is allocated to the tenant's congested links in proportion to each link's capacity.

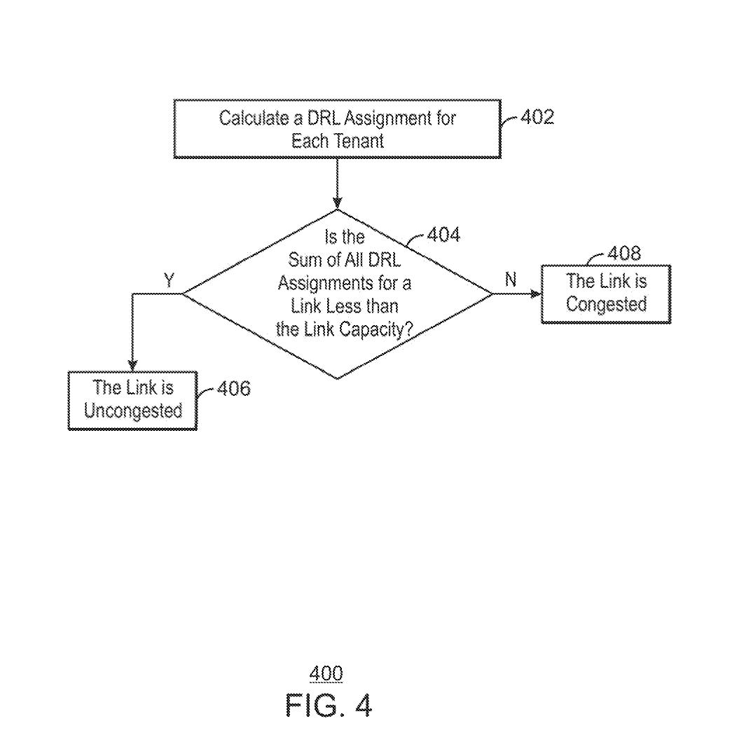

FIG. 4 is process flow diagram 400 that identifies congested and uncongested links within a network using distributed rate limiting (DAL), in accordance with examples. Congested and uncongested links within a network may be identified as in block 302 of FIG. 3. At block 402, a DRL assignment is calculated for each tenant of the network. The estimated traffic demand of the tenant on each link and the bandwidth cap of the tenant are used to determine the maximum amount of traffic that each tenant should be able to send on each link, which is referred to as the DRL assignment. As noted above, the bandwidth cap is the specified maximum bandwidth of a particular component. The bandwidth cap of a tenant may be specified in an SLA. The estimated traffic demand of each tenant may be determined by the network provider or projected by the tenant. At block 404, the sum of all DRL assignments for each link is found and a determination is made for each link regarding whether the sum of all DRL assignments for the link is less than the capacity of the link. At block 406, if the sum of all DRL assignments for the link is less than the link capacity, the link is identified as uncongested and the global bandwidth owed may be allocated for each tenant that uses the uncongested link. At block 408, if the sum of all DRL assignments for the link is greater than the link capacity, the link is identified as congested.

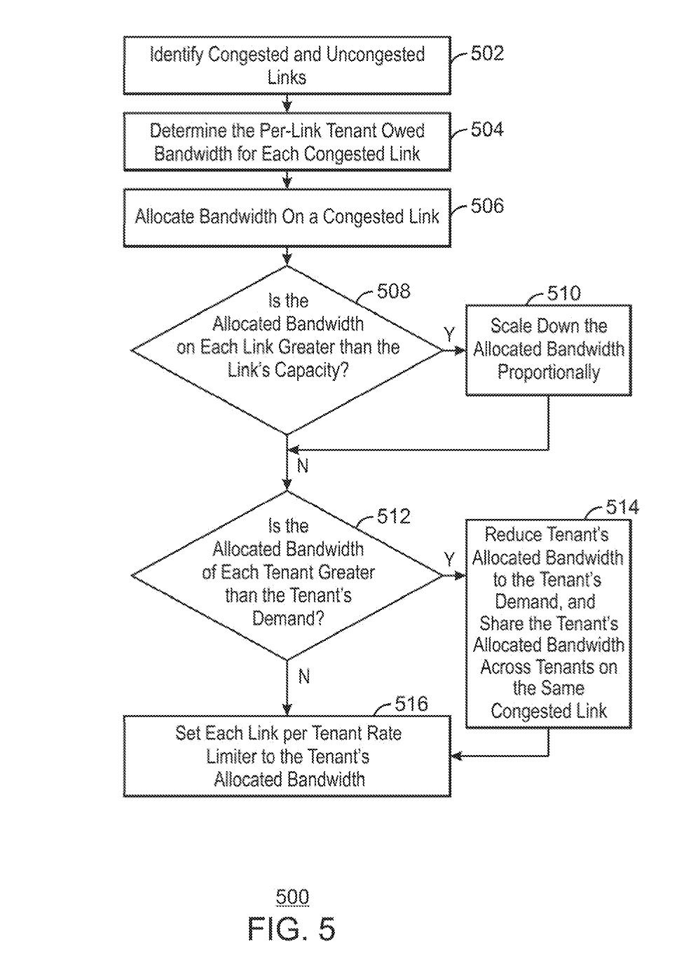

FIG. 5 is a process flow diagram 500 that allocates network bandwidth, in accordance with examples. At block 502, congested and uncongested links within a network may be identified using DRL, as specified in block 302 of FIG. 3 or FIG. 4. At block 504, the tenant owed bandwidth per each congested link is determined. For every congested link where the tenant has some demand, the tenant owed bandwidth may be calculated as the global tenant owed bandwidth multiplied by the link capacity and divided by the sum of the capacity of all the congested links where the tenant has a demand. Additionally, as used herein, a tenant has a demand on a link when the link is not providing the amount of bandwidth requested by the tenant.

At block 506, the each tenant is allocated bandwidth on a congested link based on the per-link tenant owed bandwidth. At block 508, it is determined if the sum of the allocated bandwidth for each tenant on the congested link is less than that link's capacity. If the sum of the allocated bandwidth for each tenant on a link is greater than that link's capacity, process flow continues to block 510, If the sum of the allocated bandwidth for each tenant on a link is not greater than that link's capacity, process flow continues to block 512.

At block 510, the allocated bandwidth for each tenant is proportionally scaled down when the sum of the allocated bandwidth for all tenants using the link is greater than the link capacity, In this manner, the capacity of a link is not exceeded and the link is not congested. Each tenant is allocated a share of bandwidth on the link based on the link capacity.

At block 512, it is determined if the allocated bandwidth for a tenant on a congested link is greater than the tenant's demand for bandwidth on that link. If the allocated bandwidth for a tenant on a congested link is greater than the tenant's demand for bandwidth on that link, process flow continues to block 514. If the allocated bandwidth for a tenant on a congested link is not greater than the tenant's demand for bandwidth on that link, process flow continues to block 516.

At block 514, the tenant's unused allocated bandwidth is shared across the other tenants on the same congested link in proportion to each tenant's allocated bandwidth on the congested link, and process flow continues to block 516. Unused allocated bandwidth is the allocated bandwidth minus the demand of the tenant on the congested link.

At block 516, the allocated bandwidth is distributed on each congested link where the tenant has a demand for bandwidth. In this manner, the tenants are segregated by identifying contended links and sharing the links in the presence of multiple network tenants. The fairness occurs in that each tenant is allocated the quantity of bandwidth that each tenant is owed based on each tenant's global usage of the network, and not merely the usage of a link.

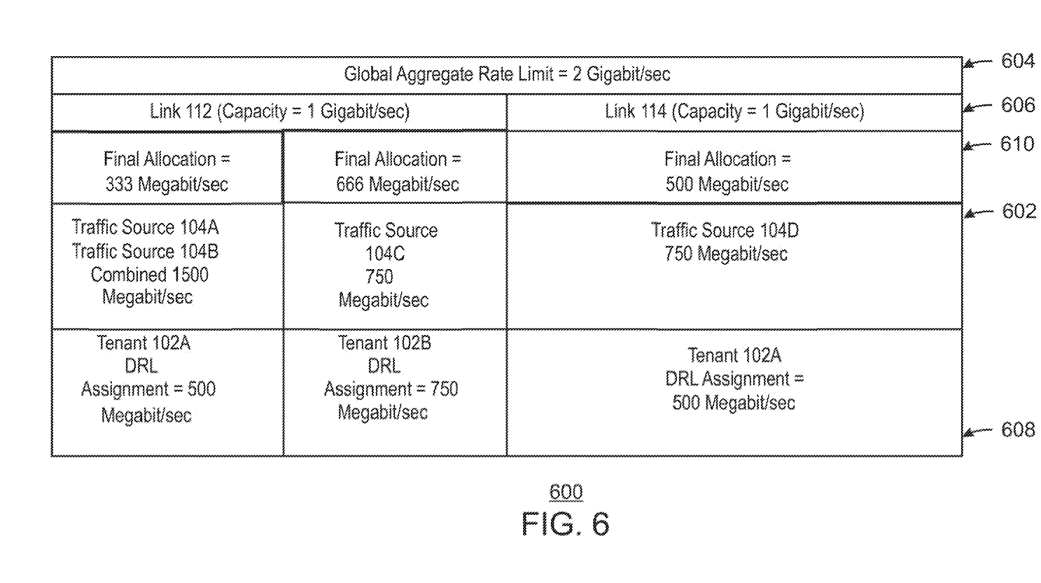

FIG. 6 is a table 600 that illustrates the allocation of bandwidth, in accordance with examples. In FIG. 6, traffic source 104A and traffic source 104B may be addressed as one traffic source as a result of both traffic source 104A and traffic source 104B using the same link 112 and same tenant 102A. For ease of description, row 602 shows each traffic source with a demand of 750 megabits per second. Thus, the combination of traffic source 104A and traffic source 104B has a total demand of 1500 megabits per second. Additionally, for ease of description, each tenant has a bandwidth cap of 1 gigabit per second.

The network capacity is shown as the global aggregate rate limit of 2 gigabits per second in row 604 of table 600. Accordingly, each link has a capacity of 1 gigabit per second, as shown in row 606. The DRL assignment for each tenant may be calculated using an estimated traffic demand of the tenant on each link and the bandwidth cap of the tenant. Accordingly, for tenant 102A, the DRL assignment on link 114 may be calculated using the bandwidth cap of 1 gigabit per second. During allocation, the bandwidth cap is shared equally among each link where the tenant has traffic. Since tenant 102A has a bandwidth cap of 1 gigabit per second, shared across two links, the DRL assignment of tenant 102A on link 114 in row 608 is 500 megabits per second. The DRL assignment of tenant 102A on link 112 in row 608 is also 500 megabits per second. The demand of traffic source 104D is greater than the DRL assignment of tenant 102A on link 114. As a result, link 114 is uncongested and shows a final allocation in row 610 of 500 megabits per second to tenant 102A.

For tenant 102B, the entire bandwidth cap of 1 gigabit per second is placed on a single link, specifically link 112. However, the demand of traffic source 104C is less than the bandwidth cap of tenant 102B on link 112. As a result, the DRL assignment of tenant 102B on link 112 in row 608 is limited to the demand of traffic source 104C at 750 megabits per second. The tenant owed bandwidth for tenant 102B on link 112 is 1 gigabit per second. The final allocation of bandwidth is determined by dividing the tenant owed bandwidth by the sum of bandwidth owed to all tenants on the link. In this example, the total owed bandwidth of link 112 is 1500 megabits per second. Accordingly, the final allocation in row 610 of tenant 102B on link 112 is 666 megabits per second. Similarly, the final allocation in row 610 of tenant 102A on link 112 is 333 megabits per second, as the owed bandwidth for tenant 102A on link 112 is 500 megabits per second.

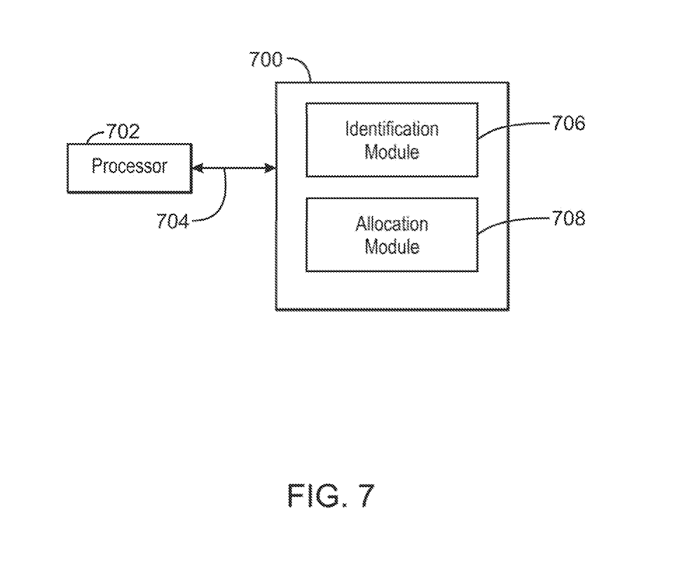

FIG. 7 is a block diagram showing a tangible, non-transitory computer-readable medium 700 that stores code configured to implement global tenant segregation, in accordance with examples. The computer-readable medium 700 may be accessed by a processor 702 over a computer bus 704. Furthermore, the computer-readable medium 700 may include code to direct the processor 702 to perform the steps of the current method.

The various software components discussed herein may be stored on the tangible, non-transitory computer-readable medium, as indicated in FIG. 7. For example, an identification module 706 may identify congested and uncongested links within a network using distributed rate limiting. An allocation module 708 may allocate global owed bandwidth to the tenant's uncongested links. Additionally, the allocation module 708 may allocate the remaining global owed bandwidth to the tenant's congested links, in proportion to each congested link's capacity. Further, the tangible, non-transitory computer-readable medium may include any number of additional software components not shown in FIG. 7.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for allocating bandwidth in a network, comprising:
identifying congested and uncongested links for a tenant using a tenant demand for each link and a tenant bandwidth cap;
allocating a portion of the tenant bandwidth cap to each uncongested link based on the tenant demand on the uncongested link and the tenant bandwidth cap; and
allocating the remainder of the tenant bandwidth cap to the tenant's congested links based on a link capacity.

2. The method of claim 1, wherein the congested and uncongested links are identified using distributed rate limiting comprising:
calculating a distributed rate limiting assignment for each tenant;
finding the sum of all distributed rate limiting assignments for each link;
identifying a link as uncongested if the sum of all distributed rate limiting assignments for the link is less than the link capacity; and
identifying a link as congested if the sum of all distributed rate limiting assignments for the link is greater than the link capacity.

3. The method of claim 1, wherein a tenant owed bandwidth is calculated as a global tenant owed bandwidth multiplied by the link capacity and divided by a sum of the capacity of all the congested links where the tenant has a demand.

4. The method of claim 1, wherein a tenant owed bandwidth for each tenant is proportionally scaled down when the sum of the tenant owed bandwidth for all tenants using the link is greater than the link capacity.

5. The method of claim 1, wherein a tenant unused bandwidth is shared across tenants on a same congested link when a demand of a tenant on a congested link is lower than a distributed rate limiting assignment of the tenant.

6. The method of claim 1, wherein the tenant is alllocated bandwidth on a congested link based on a per-link tenant owed bandwidth.

7. The method of claim 1, wherein a remaining global owed bandwidth is distributed across all congested links where the tenant has a demand.

8. A system for global tenant segregation, comprising:
a processor that is adapted to execute stored instructions; and
a storage device that stores instructions, the storage device comprising processor executable code that, when executed by the processor, is adapted to:
identify congested and uncongested links for a tenant using a tenant demand for each link and a tenant bandwidth cap;
allocate a portion of the tenant bandwidth cap to each uncongested link based on the tenant demand on the uncongested link and the tenant bandwidth cap; and
allocate the remainder of the tenant bandwidth cap to the tenant's congested links based on a link capacity.

9. The system of claim 8, wherein the congested and uncongested links are identified using distributed rate limiting comprising:
calculating a distributed rate limiting assignment for each tenant;
finding the sum of all distributed rate limiting assignments for each link;
identifying a link as uncongested if the sum of all distributed rate limiting assignments for the link is less than the link capacity; and
identifying a link as congested if the sum of all distributed rate limiting assignments for the link is greater than the link capacity.

10. The system of claim 8, wherein a tenant owed bandwidth is calculated as a global tenant owed bandwidth multiplied by the link capacity and divided by a sum of the capacity of all the congested links where the tenant has a demand.

11. The system of claim, wherein a tenant owed bandwidth for each tenant is proportionally scaled down when the sum of the tenant owed bandwidth for all tenants is using the link is greater than the link capacity.

12. The system of claim 8, wherein a tenant unused bandwidth is shared across tenants on a same congested link when a demand of a tenant on a congested link is lower than a distributed rate limiting assignment of the tenant.

13. The system of claim 8, wherein the tenant is allocated bandwidth on a congested link based on a per-link tenant owed bandwidth.

14. The system of claim 8, wherein a remaining global owed bandwidth is distributed across all congested links where the tenant has a demand.

15. A tangible, non-transitory, computer-readable medium comprising code to direct a processor to
identify congested and uncongested links for a tenant using a tenant demand for each link and a tenant bandwidth cap;
allocate a portion of the tenant bandwidth cap to each uncongested link based on the tenant demand on the uncongested link and the tenant bandwidth cap; and
allocate the remainder of the tenant bandwidth cap to the tenant's congested links based on a link capacity.
